(19) United States
(12) Patent Application Publication
(10) Pub. No.: US 2025/0065674 A1
(43) Pub. Date: Feb. 27, 2025

(54) PNEUMATIC TIRE

(71) Applicant: Sumitomo Rubber Industries, Ltd., Kobe-shi (JP)

(72) Inventor: Yuichi ISHIGAKI, Kobe-shi (JP)

(73) Assignee: Sumitomo Rubber Industries, Ltd., Kobe-shi (JP)

(21) Appl. No.: 18/788,177

(22) Filed: Jul. 30, 2024

(30) Foreign Application Priority Data
Aug. 23, 2023 (JP) 2023-135711
Jun. 18, 2024 (JP) 2024-098279

(51) Int. Cl. B60C 15/06; B60C 13/00; B60C 15/00

(52) U.S. Cl. CPC B60C 15/0632; B60C 15/0036; B60C 15/0635; B60C 2013/007; B60C 2015/0692

(57) ABSTRACT

A pneumatic tire can include a carcass, a belt layer, and reinforcing rubber layers. Turned-up portions of a carcass ply each include a first portion located between a body portion and the belt layer, a second portion adjacent to each reinforcing rubber layer in a tire axial direction, on an outer side in a tire radial direction with respect to a rim flange of a standardized rim, and a third portion located between the first portion and the second portion. A length of the third portion is 0.8 to 1.4 times a sum (La+Lb) of a length La of the first portion and a length Lb of the second portion.

### CROSS-REFERENCE TO RELATED APPLICATIONS

The present application claims priority to each of Japanese Patent Application JP 2023-135711, filed on Aug. 23, 2023 and Japanese Patent Application JP 2024-098279, filed on Jun. 18, 2024, the entire content of each of which is incorporated herein by reference in its entirety.

### BACKGROUND

### Field

The present disclosure relates to a pneumatic tire.

### Background Art

Japanese Laid-Open Patent Publication No. 2022-100772 describes a tire including a carcass formed of one carcass ply. The carcass ply has a ply body portion and a pair of turned-up portions. Ends of the turned-up portions are respectively located inward of ground-contact ends of the tread in an axial direction.

In recent years, pneumatic tires have been required to achieve weight reduction while maintaining durability.

### SUMMARY

According to one or more aspects of the present disclosure, a pneumatic tire can include a tread portion, a pair of sidewall portions, a pair of bead portions respectively having bead cores, a carcass extending between the pair of bead portions, a belt layer disposed outward of the carcass in a tire radial direction, and reinforcing rubber layers respectively provided at the pair of bead portions. The carcass is a carcass ply which includes a body portion extending between the bead cores of the pair of bead portions, and a pair of turned-up portions respectively turned up around the bead cores from an inner side toward an outer side in a tire axial direction, extending outward in the tire radial direction, and having outer ends. In a tire meridional cross-section in a standardized state where the pneumatic tire is fitted on a standardized rim and inflated to a standardized internal pressure and no load is applied to the pneumatic tire, each of the pair of turned-up portions includes a first portion located between the body portion and the belt layer, a second portion adjacent to each reinforcing rubber layer in the tire axial direction, on an outer side in the tire radial direction with respect to a rim flange of the standardized rim, and a third portion disposed between the first portion and the second portion. A length of the third portion can be 0.8 to 1.4 times a sum of a length of the first portion and a length of the second portion.

### BRIEF DESCRIPTION OF THE DRAWINGS

FIG. 1 is a tire meridional cross-sectional view of the right half of a pneumatic tire according to one or more embodiments of the present disclosure;

FIG. 2 is a development of a carcass ply;

FIG. 3 is an enlarged view of a bead portion in FIG. 1;

FIG. 4 is a sectional view taken along a line A-A in FIG. 3; and

FIG. 5 is an enlarged view of the bead portion in FIG. 1.

### DETAILED DESCRIPTION

One or more embodiments of the present disclosure have been made in view of the above circumstances, and an object of one or more embodiments of the present disclosure, among one or more objects, can be to provide a pneumatic tire capable of achieving weight reduction while maintaining durability.

Thus, the pneumatic tire according to one or more embodiments of the present disclosure can have a configuration that can achieve weight reduction while maintaining durability.

Hereinafter, an embodiment of the present disclosure will be described with reference to the drawings. The drawings contain exaggerated expressions and expressions that differ from the dimensional ratio of the actual structure in order to help the understanding of the present invention. In addition, when there are a plurality of embodiments, the same or common elements are denoted by the same reference characters throughout the description, and the redundant description thereof is omitted.

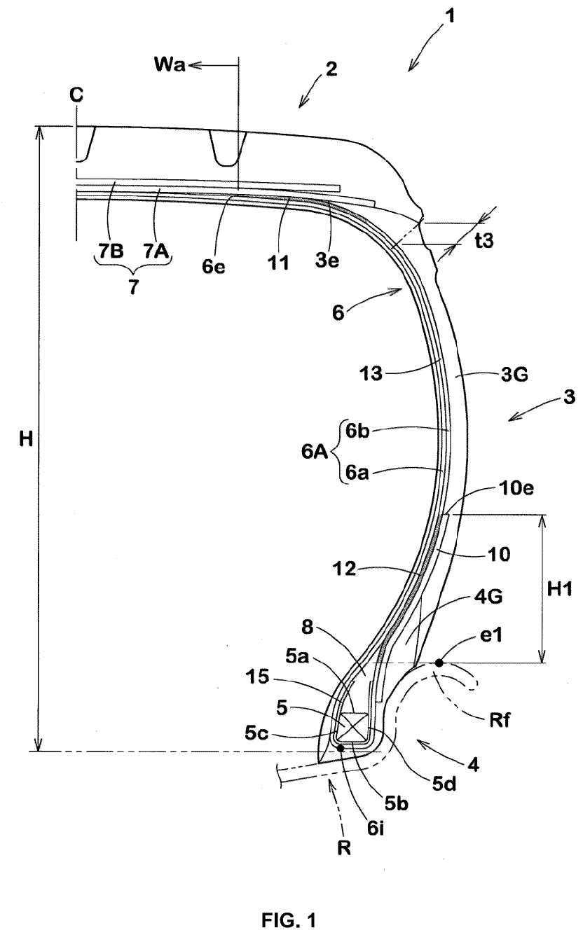

FIG. 1 is a tire meridional cross-sectional view, including a tire rotation axis, of the right half of a pneumatic tire (hereinafter, may be simply referred to as “tire”) 1 according to one or more embodiments of the present disclosure. FIG. 1 shows the tire 1 for a passenger car. One or more embodiments of the present disclosure may be suitable for a tire to be mounted to a commercial vehicle (e.g., van) designed for high-load applications. However, embodiments of the present disclosure may be applied to a tire 1 for a small-sized truck or a heavy-load vehicle, for example.

In the present description, unless otherwise specified, dimensions and the like of components of the tire 1 are values measured in a standardized state. The “standardized state” can be regarded as a state where the tire 1 is fitted on a standardized rim (hereinafter, may be simply referred to as “rim”) R and inflated to a standardized internal pressure and no load is applied to the tire 1.

The “standardized rim R” can be regarded as a rim that is defined, in a standard system including a standard on which the tire is based, by the standard for each tire, and can be, for example, the “standard rim” in the JATMA standard, the “Design Rim” in the TRA standard, or the “Measuring Rim” in the ETRTO standard.

The “standardized internal pressure” can be regarded as an air pressure that is defined, in a standard system including a standard on which the tire is based, by the standard for each tire, and can be the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard, as examples.

The tire 1 of the present embodiment can include a tread portion 2, a pair of sidewall portions 3, and a pair of bead portions 4 respectively having bead cores 5. FIG. 1 shows only one of the sidewall portions 3 and one of the bead portions 4. In the present embodiment, the tire 1 can also include a carcass 6 extending between the pair of bead portions 4, a belt layer 7 disposed outward of the carcass 6 in a tire radial direction, and reinforcing rubber layers 10 respectively provided at the pair of bead portions 4.

The carcass 6 can be a carcass ply 6A which can include a body portion 6a extending between the bead cores 5 of the pair of bead portions 4, and a pair of turned-up portions 6b respectively turned up around the bead cores 5 from an inner side toward an outer side in a tire axial direction, extending outward in the tire radial direction, and having outer ends 6e. Thus, the carcass 6 of the present embodiment can be formed of one carcass ply 6A, which can thus achieve weight reduction.

In the tire meridional cross-section in a standardized state, the pair of turned-up portions 6b can include first portions 11, second portions 12, and third portions 13. The first portions 11 can be located between the body portion 6a and the belt layer 7. The second portions 12 can be adjacent to the reinforcing rubber layers 10 in the tire axial direction, on an outer side in the tire radial direction with respect to rim flanges Rf of the rim R. The third portions 13 can be located between the first portions 11 and the second portions 12. The first portions 11 and the second portions 12 can be respectively supported by the belt layer 7 and the reinforcing rubber layers 10, and tension that acts on each turned-up portion 6b can be alleviated, thereby maintaining durability. In addition, the reinforcing rubber layers 10 can serve to keep the carcass ply 6A away from the rim flanges Rf, whereby damage to the carcass ply 6A can be inhibited, thereby maintaining durability at a higher level.

Each first portion 11 can include a portion of the turned-up portion 6b that comes into contact with the belt layer 7 when the belt layer 7 is bent on the assumption that, in a case where a rubber material (e.g., sidewall rubber 3G) is disposed between the belt layer 7 and the turned-up portion 6b, no sidewall rubber 3G is provided. In addition, the first portion 11 can be specified by a belt ply disposed on an innermost side in the tire radial direction (inner belt ply 7A in the present embodiment), in a case where the belt layer 7 is formed of a plurality of belt plies. In addition, each second portion 12 can be formed outward of an outer end e1 in the tire radial direction of each rim flange Rf, in the tire radial direction. For convenience, in FIG. 1, the first portion 11 and the second portion 12 are indicated by hatching.

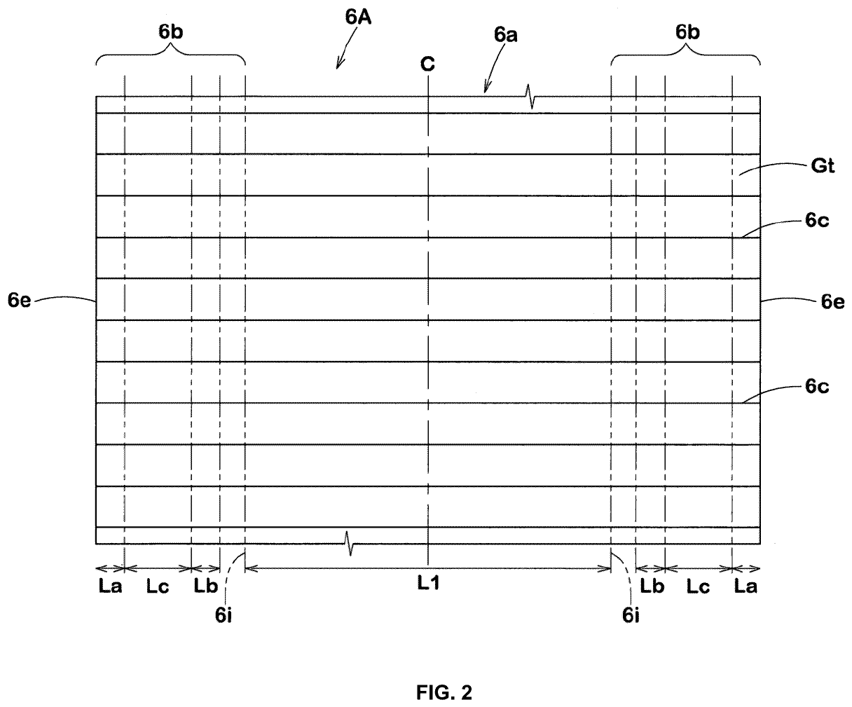

FIG. 2 is a development of the carcass ply 6A according to one or more embodiments of the present disclosure. As shown in FIG. 2, a length Lc of the third portion 13 can be not less than 0.8 times, and more preferably not less than 0.9 times a sum (La+Lb) of a length La of the first portion 11 and a length Lb of the second portion 12, and can be not greater than 1.4 times, and more preferably not greater than 1.3 times the sum (La+Lb) of the length La of the first portion 11 and the length Lb of the second portion 12. Since the length Lc of the third portion 13 can be not less than 0.8 times the sum (La+Lb), the weight reduction of tire 1 can be achieved. In addition, since the length Lc of the third portion 13 can be not greater than 1.4 times the sum (La+Lb), the effect that tension is alleviated by the first portion 11 and the second portion 12 can be maintained at a high level. Therefore, the tire 1 of one or more embodiments of the present disclosure can achieve weight reduction while maintaining durability. Such an effect can effectively contribute to, in particular, the pneumatic tire 1 to be mounted to a commercial vehicle designed for high-load applications.

In general, during running with the tire 1, a relatively large tension can act on the carcass ply 6A at the bead portions 4. Thus, the length Lb of the second portion 12 can be greater than the length La of the first portion 11. Although not particularly limited, the length Lb of the second portion 12 can be not less than 1.05 times, and more preferably not less than 1.08 times the length La of the first portion 11, and can be not greater than 1.18 times, and more preferably not greater than 1.15 times the length La of the first portion 11.

As shown in FIG. 1, in the present embodiment, the belt layer 7 can be formed of two belt plies 7A, 7B which can be respectively disposed on an inner side and an outer side in the tire radial direction. The inner belt ply 7A, for example, can terminate outward of the outer belt ply 7B in the tire axial direction. In the present embodiment, each of the belt plies 7A, 7B can have highly elastic belt cords, such as steel cords, inclined at an angle of 15 to 40° relative to a tire equator C, and a topping rubber for covering the belt cords.

As shown in FIG. 2, the carcass ply 6A can include a plurality of carcass cords 6c and a topping rubber Gt that can cover the carcass cords 6c. One or more suitable materials may be used as appropriate for the carcass cords 6c and the topping rubber Gt.

A length Wa (shown in FIG. 1) in the tire axial direction between the outer ends 6e of the pair of turned-up portions 6b can be preferably not less than 0.10 times and more preferably not less than 0.15 times a length L1 of the body portion 6a, and can be preferably not greater than 0.30 times and more preferably not greater than 0.25 times the length L1 of the body portion 6a. Since the length Wa between the outer ends 6e can be not less than 0.10 times the length L1 of the body portion 6a, the weight reduction of the tire 1 can be maintained at a high level. Since the length Wa between the outer ends 6e can be not greater than 0.30 times the length L1 of the body portion 6a, the effect of supporting the turned-up portions 6b can be highly exerted. The length L1 of the body portion 6a can be regarded as a length between positions 6i (shown in FIG. 1) located on an innermost side in the tire radial direction of the carcass ply 6A. When a plurality of the positions 6i located on the innermost side in the tire radial direction are formed, the length L1 can be regarded as the length between positions located on the innermost side in the tire radial direction and further on an innermost side in the tire axial direction.

As shown in FIG. 1, in the tire meridional cross-section, each bead core 5 of the present embodiment can be formed in a rectangular shape. The bead core 5 can include an outer surface 5a in the tire radial direction, an inner surface 5b in the tire radial direction, an inner-side surface 5c in the tire axial direction, and an outer-side surface 5d in the tire axial direction. The inner-side surface 5c and the outer-side surface 5d can be connected to the outer surface 5a and the inner surface 5b. The bead core 5 can be regarded as structure that is formed by winding a non-stretchable bead wire, for example.

In the present embodiment, an outer end 10e in the tire radial direction of each reinforcing rubber layer 10 can be preferably located outward of the outer end e1 of each rim flange Rf in the tire radial direction. With such reinforcing rubber layers 10, deflection of the bead portion 4 can be inhibited from being generated during running, and damage to the carcass ply 6A can be further suppressed. In addition, deflection of the bead portion 4 can be inhibited, whereby separation of tire components can be suppressed. Although not particularly limited, a distance H1 in the tire radial direction between the outer end 10e of the reinforcing rubber layer 10 and the outer end e1 of the rim flange Rf can be preferably not less than 15% and more preferably not less than 20% of a tire cross-sectional height H, and can be preferably not greater than 35% and more preferably not greater than 30% of the tire cross-sectional height H. In the present description, the “tire cross-sectional height H” can be regarded as a distance in the tire radial direction from a bead base line BL to an outermost-side position in the tire radial direction. In addition, the “bead base line BL” can be regarded as a line passing, in the tire axial direction, through a rim diameter (see JATMA) position defined by the standard on which the tire 1 is based.

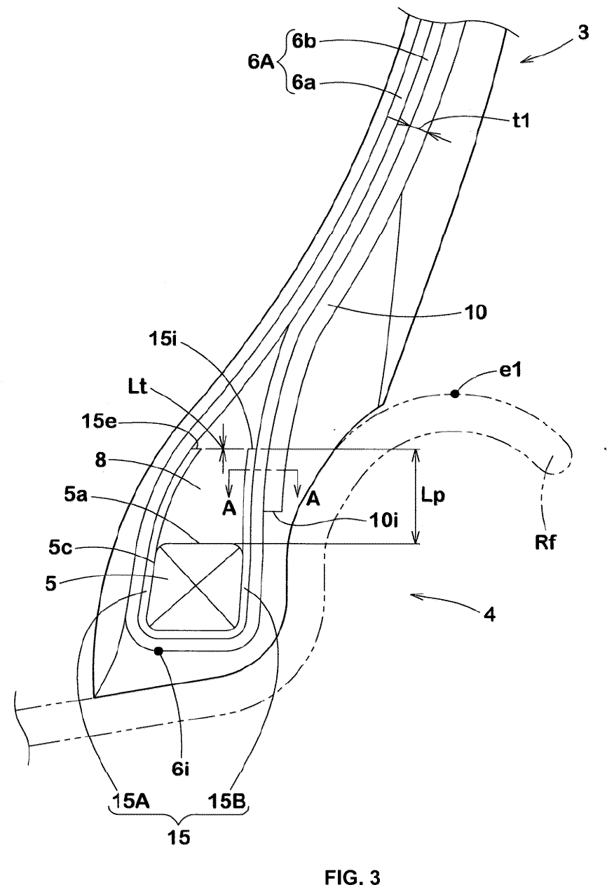

FIG. 3 is an enlarged view of the bead portion 4 in FIG. 1. As shown in FIG. 1 and FIG. 3, an inner end 10i in the tire radial direction of each reinforcing rubber layer 10 can be located outward of the outer surface 5a in the tire radial direction of each bead core 5, in the tire radial direction. Such reinforcing rubber layers 10 can suppress increase in mass of the tire 1. In addition, the inner end 10i of the reinforcing rubber layer 10 can be, for example, located inward of the outer end e1 of each rim flange Rf in the tire radial direction. Thus, the stiffness of the bead portions 4 can be maintained at a high level.

The reinforcing rubber layer 10 can be, for example, formed of a sheet-shaped rubber member. Such reinforcing rubber layers 10 can enhance the stiffness of the bead portions 4 uniformly in the tire radial direction, and can inhibit increase in the mass of the tire 1. A thickness (maximum thickness) t1 of each reinforcing rubber layer 10 can be 0.5 to 3.0 mm, as an example. In addition, for example, a complex elastic modulus E*c of the reinforcing rubber layer 10 can be preferably not less than 15 MPa and more preferably not less than 20 MPa, and can be preferably not greater than 100 MPa and more preferably not greater than 80 MPa. Thus, the stiffness of the bead portions 4 can be maintained at a high level. In the present description, the complex elastic modulus E* can be regarded as a value measured by using a viscoelasticity spectrometer such as “EPLEXOR (registered trademark)” manufactured by GABO under the following conditions in accordance with JIS K 6394.
Initial strain: 10%
Amplitude: ±2%
Frequency: 10 Hz
Deformation mode: tension
Temperature: 70° C.

As shown in FIG. 1, the tire 1 of the present embodiment can further include bead apex rubbers 8, reinforcing layers 15, the sidewall rubbers 3G, and clinch rubbers 4G. For example, the bead apex rubbers 8 can be respectively provided at the pair of bead portions 4, and can extend outward in the tire radial direction from the outer surfaces 5a in the tire radial direction of the bead cores 5. For example, the reinforcing layers 15 can be respectively provided at the pair of bead portions 4, and can each be disposed between the bead core 5 and the carcass ply 6A. In the present embodiment, the sidewall rubbers 3G can be disposed outward of the turned-up portions 6b in the tire axial direction, and can be adjacent to the third portions 13. For example, each clinch rubber 4G can be located outward of the reinforcing rubber layer 10 in the tire axial direction, and can form an outer surface, of the tire 1, in contact with the rim R.

As shown in FIG. 3, each reinforcing layer 15 of the present embodiment can include an inner-side portion 15A and an outer-side portion 15B. The inner-side portion 15A can be adjacent to the inner-side surface 5c of each bead core 5, for example. The outer-side portion 15B can be connected to the inner-side portion 15A, and can be turned up around the bead core 5 from the inner side toward the outer side in a the tire axial direction and can extend outward in the tire radial direction, for example.

An outer end 15e of the inner-side portion 15A and an outer end 15i of the outer-side portion 15B can be located outward of the outer surface 5a of the bead core 5 in the tire radial direction. In addition, the outer end 15e of the inner-side portion 15A and the outer end 15i of the outer-side portion 15B can be located outward of the inner end 10i in the tire radial direction of the reinforcing rubber layer 10, in the tire radial direction. Such reinforcing layers 15 can reduce a possibility that each bead core 5 and the carcass ply 6A come into contact with each other. Thus, there can be less risk of breaking of the carcass cords 6c of the carcass ply 6A, thereby improving durability. The outer end 15e of the inner-side portion 15A and the outer end 15i of the outer-side portion 15B can be located inward of the outer end e1 of the rim flange Rf in the tire radial direction.

The outer end 15e in the tire radial direction of the inner-side portion 15A and the outer end 15i in the tire radial direction of the outer-side portion 15B can be at the same position in the tire radial direction. Such reinforcing layers 15 can suppress movement of the bead cores 5 and/or rotation around the shown bead cores 5, thereby further inhibiting contact between the carcass ply 6A and each bead core 5. In the present description, the “same position” can refer to not only a case where a separation distance Lt in the tire radial direction between the outer end 15e and the outer end 15i is 0 mm but also a case where the separation distance Lt is not greater than 3 mm.

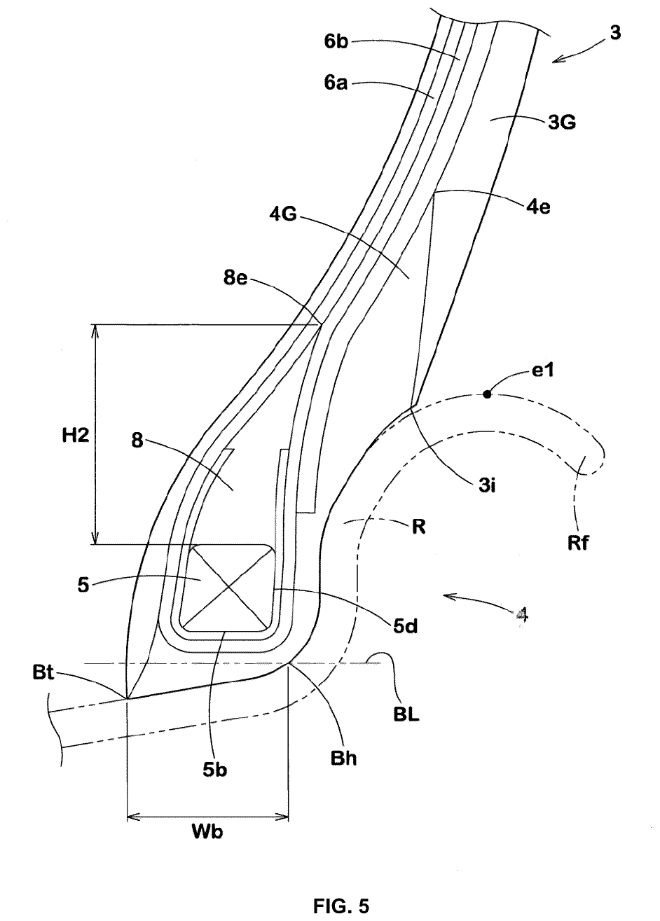

A distance Lp in the tire radial direction between the outer end 15i of the outer-side portion 15B and the outer surface 5a of the bead core 5 can be preferably not less than 30% and more preferably not less than 35% of a height H2 (shown in FIG. 5) in the tire radial direction of each bead apex rubber 8, and can be preferably not greater than 50% and more preferably not greater than 45% of the height H2 in the tire radial direction of the bead apex rubber 8. Since the distance Lp is not less than 30% of the height H2 of the bead apex rubber 8, contact between the carcass ply 6A and each bead core 5 can be effectively suppressed. Since the distance Lp may be not greater than 50% of the height H2 of the bead apex rubber 8, the adhesion strength between each bead apex rubber 8 and the carcass ply 6A can be maintained at a high level, thereby inhibiting damage due to separation. The height H2 of the bead apex rubber 8 can be a length in the tire radial direction between an outer end 8e of the bead apex rubber 8 and the outer surface 5a of the bead core 5.

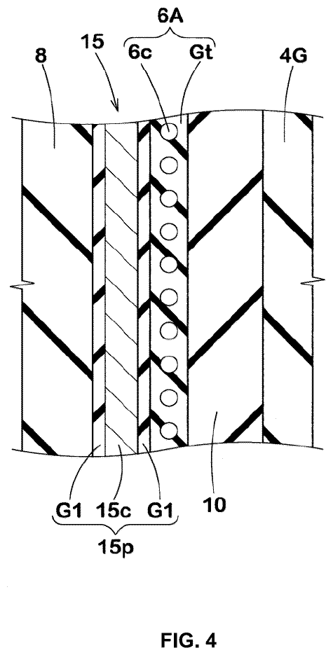

FIG. 4 is a sectional view taken along a line A-A in FIG. 3. As shown in FIG. 4, in the present embodiment, each reinforcing layer 15 can be a reinforcing ply 15p including a plurality of organic fiber cords 15c and a first rubber G1 for covering the organic fiber cords 15c. For the organic fiber cords 15c, for example, polyester fibers, nylon fibers, rayon fibers, vinylon fibers, aramid fibers, or polyurethane fibers can be used.

A product (Ca×E*1) of a cord density Ca of the carcass ply 6A and a complex elastic modulus E*1 of the topping rubber Gt can be greater than a product (Cb×E*2) of a cord density Cb of the reinforcing ply 15p and a complex elastic modulus E*2 of the first rubber G1. Thus, the reinforcing layer 15 can be accurately disposed along the inner-side surface 5c or the inner surface 5b of each bead core 5, and damage to the carcass ply 6A can be suppressed. The product (Ca×E*1) can be, for example, preferably 90000 to 110000 (the number of the cords·MPa). The product (Cb×E*2) can be, for example, preferably 15000 to 25000 (the number of the cords·MPa). In the present description, the “cord density” can be the number of cords included per ply width of 50 mm in each ply.

FIG. 5 is an enlarged view of the bead portion 4 in FIG. 1. As shown in FIG. 5, each bead apex rubber 8 can be inclined outward in the tire axial direction, toward the outer side in the tire radial direction. For the bead apex rubber 8 of the present embodiment, a suitable bead apex rubber can be used as appropriate.

The outer end 8e in the tire radial direction of the bead apex rubber 8 can be, for example, located outward of the outer end e1 of each rim flange Rf in the tire radial direction. Thus, deflection of the bead portions 4 during running can be further suppressed, and, for example, separation between the carcass ply 6A and each reinforcing rubber layer 10, separation between the body portion 6a and each turned-up portion 6b, or the like can be inhibited, thereby improving durability. In the present embodiment, the bead apex rubber 8 can extend inward and outward of the outer end e1 of the rim flange Rf in the tire radial direction.

The height H2 in the tire radial direction of the bead apex rubber 8 can be not greater than 30 mm, for instance, not greater than 28 mm. Since the height H2 of the bead apex rubber 8 can be not greater than 30 mm, the outer end 8e of the bead apex rubber 8 and a bending point to be generated in the bead portion 4 during running can be inhibited from coming excessively close to each other, thereby maintaining durability at a high level. Although not particularly limited, the height H2 of the bead apex rubber 8 can be not less than 5 mm, for instance, not less than 10 mm.

In the present embodiment, the inner end 3i in the tire radial direction of each sidewall rubber 3G can be located inward of the outer end e1 of the rim flange Rf in the tire radial direction. An outer end 3e (shown in FIG. 1) in the tire radial direction of the sidewall rubber 3G can be, for example, located between the inner belt ply 7A and each turned-up portion 6b.

A thickness (maximum thickness) t3 (shown in FIG. 1) of each sidewall rubber 3G can be preferably not less than 2.0 mm and more preferably not less than 2.5 mm, and can be preferably not greater than 6.0 mm and more preferably not greater than 5.0 mm. Since the thickness t3 of the sidewall rubber 3G can be not less than 2.0 mm, the stiffness of the sidewall portion 3 can be enhanced. Since the thickness t3 of the sidewall rubber 3G can be not greater than 6.0 mm, weight reduction in the tire 1 can be maintained. The thickness t3 of the sidewall rubber 3G can be regarded as a length in the direction normal to an outer surface in the tire axial direction of the turned-up portion 6b of the carcass ply 6A.

In the present embodiment, an outer end 4e in the tire radial direction of each clinch rubber 4G can be located outward of the outer end 8e of the bead apex rubber 8 in the tire radial direction. The clinch rubber 4G can be adjacent to the outer-side surface 5d of each bead core 5 and can extend inward of the inner surface 5b of the bead core 5 in the tire radial direction, for example.

A complex elastic modulus E*5 of each bead apex rubber 8 can be preferably not less than 15 MPa and more preferably not less than 20 MPa, and can be preferably not greater than 100 MPa and more preferably not greater than 80 MPa. In addition, a complex elastic modulus E*6 of each sidewall rubber 3G can be preferably not less than 3 MPa and more preferably not less than 5 MPa, and can be preferably not greater than 20 MPa and more preferably not greater than 15 MPa. A complex elastic modulus E*7 of each clinch rubber 4G can be preferably not less than 5 MPa and more preferably not less than 8 MPa, and can be preferably not greater than 20 MPa and more preferably not greater than 15 MPa.

Bead toes Bt can each be an innermost contact point with the rim R in the tire axial direction. Bead heels Bh can each be a point that is in contact with the rim R and lies on the bead base line BL. A length Wb in the tire axial direction between the bead toe Bt and the bead heel Bh at each of the pair of bead portions 4 can be not greater than 16 mm, as an example. With such length Wb, rim fittability when the tire 1 is fitted on the rim R can be improved. In order to ensure stability during running, the length Wb can be not less than 12 mm, for instance.

Although aspects of one or more embodiments have been described in detail above, one or more embodiments of the present disclosure are not limited to the illustrated embodiment, and various modifications can be made to implement one or more embodiments of the present disclosure.

### Examples

Pneumatic tires for light truck with a size of 205/85R16LT having the basic structure in FIG. 1 were produced as test tires on the basis of specifications in Table 1. Each test tire was tested for weight reduction, and durability. The test method is as follows.

### <Weight Reduction>

The mass of each test tire was measured. The result was indicated as an index with the reciprocal of the mass of the tire of Comparative Example 3 being regarded as 100. The higher the numerical value is, the smaller the mass of the tire is and the more favorable the result is.

### <Durability>

Running with each test tire set on a drum tester under the following conditions was performed, and the running distance was measured when carcass cord damage or separation damage occurred. The carcass cord damage means damage caused due to the carcass cord being broken around the bead core. The separation damage means separation between the carcass ply and a constituent material adjacent thereto or separation between the carcass plies. The running distance was evaluated when one of the carcass cord damage or the separation damage occurred. The result was indicated as an index with the running distance of Comparative Example 1 being regarded as 60. A numerical value not less than 90 is acceptable.
Internal pressure: 600 kPa
Load: 19.84 kN
Running speed: 80 km/h
The test results are shown in Table 1 and Table 2.

In Table 1, “Two” indicates an example in which two carcass plies were disposed and the outer ends 6e of the turned-up portions of each carcass ply were located at a tire maximum width position.
In Tables 1 and 2, “A” means “8e>e1>15e, 15i”, and “B” means “e1>8e>15e, 15i”.
Further, in Tables 1 and 2, “C” means “(Ca×E*1)>(Cb×E*2)”, and “D” means “(Ca×E*1)<(Cb×E*2)”.

In Tables 1 and 2, “Presence” means that the reinforcing layer was formed of a reinforcing ply, and “Presence*” means that the reinforcing layer was formed of only rubber.

Further, Comparative Example 1 is an example in which the height H2 in the tire radial direction of the bead apex rubber was the same height as that in FIG. 1, and Comparative Example 2 is an example in which the height H2 of the bead apex rubber was set so as to have a durability of 100.

TABLE 1

| | Comp. | Comp. | Comp. | Comp. | | | | |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| Shape of carcass ply | Two | Two | FIG. 1 | FIG. 1 | FIG. 1 | FIG. 1 | FIG. 1 | FIG. 1 |
| Shape of bead portion | no | no | FIG. 3 | FIG. 3 | FIG. 3 | FIG. 3 | FIG. 3 | FIG. 3 |
| | reinforcing | reinforcing | | | | | | |
| | rubber | rubber | | | | | | |
| | layer | layer | | | | | | |
| Presence/absence of | Absence | Absence | Presence | Presence | Presence | Presence | Presence | Presence |
| reinforcing layer | | | | | | | | |
| Lc/(La + Lb) | — | — | 0.7 | 1.5 | 0.8 | 0.9 | 1.3 | 1.4 |
| Positions of 8e, 15e, e1 | — | — | A | A | A | A | A | A |
| Wa/L1 | — | — | 0.2 | 0.2 | 0.2 | 0.2 | 0.2 | 0.2 |
| Relationship between | — | — | C | C | C | C | C | C |
| (CaxE*1) and (CbxE*2) | | | | | | | | |
| Wb (mm) | 16 | 16 | 16 | 16 | 16 | 16 | 16 | 16 |
| Weight reduction [Index, | 140 | 100 | 120 | 140 | 123 | 125 | 130 | 135 |
| higher numerical value is | | | | | | | | |
| better] | | | | | | | | |
| Durability [Index, higher | 80 | 100 | 88 | 85 | 95 | 100 | 105 | 100 |
| numerical value is better] | | | | | | | | |

TABLE 2

| | Ex. 5 | Ex. 6 | Ex. 7 | Ex. 8 | Ex. 9 | Ex. 10 | Ex. 11 |
|---|---|---|---|---|---|---|---|
| Shape of carcass ply | FIG. 1 | FIG. 1 | FIG. 1 | FIG. 1 | FIG. 1 | FIG. 1 | FIG. 1 |
| Shape of bead portion | FIG. 3 | FIG. 3 | FIG. 3 | FIG. 3 | FIG. 3 | FIG. 3 | FIG. 3 |
| Presence/absence of reinforcing | Presence | Presence* | Absence | Presence | Presence | Presence | Presence |
| layer | | | | | | | |
| Lc/(La + Lb) | 1.2 | 1.2 | 1.2 | 1.2 | 1.2 | 1.2 | 1.2 |
| Positions of 8e, 15e, e1 | A | A | A | A | B | A | A |
| Wa/L1 | 0.2 | 0.2 | 0.2 | 0.2 | 0.2 | 0.4 | 0.2 |
| Relationship between (CaxE*1) | C | C | C | C | C | C | D |
| and (CbxE*2) | | | | | | | |
| Wb (mm) | 16 | 16 | 16 | 18 | 16 | 16 | 17 |
| Weight reduction [Index, higher | 127 | 132 | 135 | 127 | 130 | 135 | 127 |
| numerical value is better] | | | | | | | |
| Durability [Index, higher | 110 | 100 | 90 | 105 | 100 | 95 | 105 |
| numerical value is better] | | | | | | | |

As shown in Tables 1 and 2, it is understood that the weight reduction of the tires of the Examples is maintained and durability thereof is improved as compared to those of the tires of the Comparative Examples.

### [Additional Note]

One or more embodiments of the present disclosure can include some or all of the following aspects.

### [Present Disclosure 1]

A pneumatic tire including:
a tread portion;
a pair of sidewall portions;
a pair of bead portions respectively having bead cores;
a carcass extending between the pair of bead portions;
a belt layer disposed outward of the carcass in a tire radial direction; and
reinforcing rubber layers respectively provided at the pair of bead portions, wherein
the carcass is a carcass ply which includes a body portion extending between the bead cores of the pair of bead portions, and a pair of turned-up portions respectively turned up around the bead cores from an inner side toward an outer side in a tire axial direction, extending outward in the tire radial direction, and having outer ends, and
in a tire meridional cross-section in a standardized state where the pneumatic tire is fitted on a standardized rim and inflated to a standardized internal pressure and no load is applied to the pneumatic tire,
   each of the pair of turned-up portions includes a first portion located between the body portion and the belt layer, a second portion adjacent to each reinforcing rubber layer in the tire axial direction, on an outer side in the tire radial direction with respect to a rim flange of the standardized rim, and a third portion disposed between the first portion and the second portion, and
   a length of the third portion is 0.8 to 1.4 times a sum of a length of the first portion and a length of the second portion.

### [Present Disclosure 2]

The pneumatic tire according to Present Disclosure 1, wherein a length in the tire axial direction between the outer ends of the pair of turned-up portions is 0.1 to 0.3 times a length of the body portion.

### [Present Disclosure 3]

The pneumatic tire according to Present Disclosure 1 or 2, wherein each of the pair of bead portions includes a reinforcing layer provided between the bead core and the carcass ply.

### [Present Disclosure 4]

The pneumatic tire according to Present Disclosure 3, wherein
each of the pair of bead portions includes a bead apex rubber extending outward in the tire radial direction from an outer surface in the tire radial direction of the bead core, and
in the standardized state,
an outer end in the tire radial direction of the bead apex rubber and an outer end in the tire radial direction of the reinforcing rubber layer are located outward of an outer end in the tire radial direction of the rim flange of the standardized rim, in the tire radial direction.

### [Present Disclosure 5]

The pneumatic tire according to Present Disclosure 3 or 4, wherein
the reinforcing layer includes an inner-side portion adjacent to an inner-side surface in the tire axial direction of the bead core, and an outer-side portion which is connected to the inner-side portion and is turned up around the bead core from the inner side toward the outer side in the tire axial direction and extends outward in the tire radial direction, and
an outer end in the tire radial direction of the inner-side portion and an outer end in the tire radial direction of the outer-side portion are located at the same position, in the tire radial direction.

### [Present Disclosure 6]

The pneumatic tire according to Present Disclosure 5, wherein the outer end in the tire radial direction of the inner-side portion and the outer end in the tire radial direction of the outer-side portion are located outward of an inner end in the tire radial direction of the reinforcing rubber layer, in the tire radial direction.

### [Present Disclosure 7]

The pneumatic tire according to any one of Present Disclosures 3 to 6, wherein the reinforcing layer is a reinforcing ply including a plurality of organic fiber cords and a first rubber for covering the organic fiber cords.

### [Present Disclosure 8]

The pneumatic tire according to any one of Present Disclosures 1 to 7, wherein the inner end in the tire radial direction of the reinforcing rubber layer is located outward of the outer surface in the tire radial direction of the bead core, in the tire radial direction.

### [Present Disclosure 9]

The pneumatic tire according to Present Disclosure 7, wherein
the carcass ply includes a plurality of carcass cords and a topping rubber for covering the carcass cords, and
a product of a cord density of the carcass ply and a complex elastic modulus of the topping rubber is greater than a product of a cord density of the reinforcing ply and a complex elastic modulus of the first rubber.

### [Present Disclosure 10]

The pneumatic tire according to any one of Present Disclosures 1 to 9, wherein
in each of the pair of bead portions, a length in the tire axial direction between a bead toe and a bead heel is not greater than 16 mm.

### [Present Disclosure 11]

The pneumatic tire according to any one of Present Disclosures 1 to 10, wherein
a sidewall rubber is provided adjacent to an outer side in the tire axial direction of the third portion, and
a thickness of the sidewall rubber is 2.0 to 6.0 mm.

### [Present Disclosure 12]

The pneumatic tire according to any one of Present Disclosures 1 to 11, wherein
the second length of the second portion is greater than the first length of the first portion.

### [Present Disclosure 13]

The pneumatic tire according to any one of Present Disclosures 1 to12, wherein in the standardized state,
an inner end in the tire radial direction of each of the reinforcing layers is outward of an outer surface of the bead core in the tire radial direction, and
the inner end of each of the reinforcing layers is inward of an outer end in the tire radial direction of the rim flange of the standardized rim, in the tire radial direction.

### [Present Disclosure 14]

A pneumatic tire comprising:
a tread portion;
a pair of sidewall portions;
a pair of bead portions respectively having bead cores;
a carcass extending between the pair of bead portions;
a belt layer outward of the carcass in a tire radial direction; and
reinforcing rubber layers respectively at the pair of bead portions, wherein
the carcass is a carcass ply which includes:
   a body portion extending between the bead cores of the pair of bead portions, and
   a pair of turned-up portions respectively turned up around the bead cores from an inner side toward an outer side in a tire axial direction, extending outward in the tire radial direction, and having outer ends, and
in a tire meridional cross-section in a standardized state where the pneumatic tire is fitted on a standardized rim and inflated to a standardized internal pressure and no load is applied to the pneumatic tire,
   each of the pair of turned-up portions includes:
   a first portion between the body portion and the belt layer,
   a second portion adjacent to each reinforcing rubber layer in the tire axial direction, on an outer side in the tire radial direction with respect to a rim flange of the standardized rim, and
   a third portion between the first portion and the second portion, and
   a third length of the third portion is 0.8 to 1.4 times a sum of a first length of the first portion and a second length of the second portion,
each of the bead portions includes a bead apex rubber extending outward in the tire radial direction from an outer surface in the tire radial direction of the bead core, and
   in the standardized state,
   an outer end in the tire radial direction of the bead apex rubber and an outer end in the tire radial direction of the reinforcing rubber layer are outward of an outer end in the tire radial direction of the rim flange of the standardized rim, in the tire radial direction.

### [Present Disclosure 15]

The pneumatic tire according to Present Disclosure 14, wherein in the standardized state,
an inner end in the tire radial direction of each of the reinforcing layers is outward of an outer surface of the bead core in the tire radial direction.

What is claimed is:

1. A pneumatic tire comprising:
a tread portion;
a pair of sidewall portions;
a pair of bead portions respectively having bead cores;
a carcass extending between the pair of bead portions;
a belt layer outward of the carcass in a tire radial direction; and
reinforcing rubber layers respectively at the pair of bead portions, wherein
the carcass is a carcass ply which includes:
a body portion extending between the bead cores of the pair of bead portions, and
a pair of turned-up portions respectively turned up around the bead cores from an inner side toward an outer side in a tire axial direction, extending outward in the tire radial direction, and having outer ends, and
in a tire meridional cross-section in a standardized state where the pneumatic tire is fitted on a standardized rim and inflated to a standardized internal pressure and no load is applied to the pneumatic tire,
each of the pair of turned-up portions includes:
a first portion between the body portion and the belt layer,
a second portion adjacent to each reinforcing rubber layer in the tire axial direction, on an outer side in the tire radial direction with respect to a rim flange of the standardized rim, and
a third portion between the first portion and the second portion, and
a third length of the third portion is 0.8 to 1.4 times a sum of a first length of the first portion and a second length of the second portion.

2. The pneumatic tire according to claim 1, wherein a length in the tire axial direction between the outer ends of the pair of turned-up portions is 0.1 to 0.3 times a length of the body portion.

3. The pneumatic tire according to claim 2, wherein each of the bead portions includes a reinforcing layer between the bead core and the carcass ply.

4. The pneumatic tire according to claim 3, wherein
each of the bead portions includes a bead apex rubber extending outward in the tire radial direction from an outer surface in the tire radial direction of the bead core, and
in the standardized state,
an outer end in the tire radial direction of the bead apex rubber and an outer end in the tire radial direction of the reinforcing rubber layer are outward of an outer end in the tire radial direction of the rim flange of the standardized rim, in the tire radial direction.

5. The pneumatic tire according to claim 3, wherein
the reinforcing layer includes an inner-side portion adjacent to an inner-side surface in the tire axial direction of the bead core, and an outer-side portion which is connected to the inner-side portion and is turned up around the bead core from the inner side toward the outer side in the tire axial direction and extends outward in the tire radial direction, and
an outer end in the tire radial direction of the inner-side portion and an outer end in the tire radial direction of the outer-side portion are at the same position in the tire radial direction.

6. The pneumatic tire according to claim 5, wherein the outer end in the tire radial direction of the inner-side portion and the outer end in the tire radial direction of the outer-side portion are outward of an inner end in the tire radial direction of the reinforcing rubber layer, in the tire radial direction.

7. The pneumatic tire according to claim 3, wherein the reinforcing layer is a reinforcing ply including a plurality of organic fiber cords and a first rubber the covers the organic fiber cords.

8. The pneumatic tire according to claim 1, wherein an inner end in the tire radial direction of the reinforcing rubber layer is located outward of an outer surface in the tire radial direction of the bead core, in the tire radial direction.

9. The pneumatic tire according to claim 7, wherein
the carcass ply includes a plurality of carcass cords and a topping rubber that covers the carcass cords, and
a product of a cord density of the carcass ply and a complex elastic modulus of the topping rubber is greater than a product of a cord density of the reinforcing ply and a complex elastic modulus of the first rubber.

10. The pneumatic tire according to claim 1, wherein
in each of the bead portions, a length in the tire axial direction between a bead toe and a bead heel is not greater than 16 mm.

11. The pneumatic tire according to claim 1, wherein
a sidewall rubber is adjacent to an outer side in the tire axial direction of the third portion, and
a thickness of the sidewall rubber is 2.0 to 6.0 mm.

12. The pneumatic tire according to claim 1, wherein
the second length of the second portion is greater than the first length of the first portion.

13. The pneumatic tire according to claim 1, wherein in the standardized state,
an inner end in the tire radial direction of each of the reinforcing layers is outward of an outer surface of the bead core in the tire radial direction, and
the inner end of each of the reinforcing layers is inward of an outer end in the tire radial direction of the rim flange of the standardized rim, in the tire radial direction.

14. A pneumatic tire comprising:
a tread portion;
a pair of sidewall portions;
a pair of bead portions respectively having bead cores;
a carcass extending between the pair of bead portions;
a belt layer outward of the carcass in a tire radial direction; and
reinforcing rubber layers respectively at the pair of bead portions, wherein
the carcass is a carcass ply which includes:
a body portion extending between the bead cores of the pair of bead portions, and
a pair of turned-up portions respectively turned up around the bead cores from an inner side toward an outer side in a tire axial direction, extending outward in the tire radial direction, and having outer ends, and
in a tire meridional cross-section in a standardized state where the pneumatic tire is fitted on a standardized rim and inflated to a standardized internal pressure and no load is applied to the pneumatic tire,
each of the pair of turned-up portions includes:
a first portion between the body portion and the belt layer,
a second portion adjacent to each reinforcing rubber layer in the tire axial direction, on an outer side in the tire radial direction with respect to a rim flange of the standardized rim, and
a third portion between the first portion and the second portion, and
a third length of the third portion is 0.8 to 1.4 times a sum of a first length of the first portion and a second length of the second portion,
each of the bead portions includes a bead apex rubber extending outward in the tire radial direction from an outer surface in the tire radial direction of the bead core, and
in the standardized state,
an outer end in the tire radial direction of the bead apex rubber and an outer end in the tire radial direction of the reinforcing rubber layer are outward of an outer end in the tire radial direction of the rim flange of the standardized rim, in the tire radial direction.

15. The pneumatic tire according to claim 14, wherein in the standardized state,
an inner end in the tire radial direction of each of the reinforcing layers is outward of an outer surface of the bead core in the tire radial direction.
